(19) United States
(12) Patent Application Publication
(10) Pub. No.: US 2018/0020374 A1
(43) Pub. Date: Jan. 18, 2018

(54) MULTIPLE MODULATION AND CODING SCHEME INDICATION SIGNALING

(71) Applicant: QUALCOMM Incorporated, San Diego, CA (US)

(72) Inventors: Assaf Yaakov KASHER, Haifa (IL); Alecsander Petru EITAN, Haifa (IL); Amichai SANDEROVICH, Atlit (IL)

(21) Appl. No.: 15/650,110

(22) Filed: Jul. 14, 2017

Related U.S. Application Data
(60) Provisional application No. 62/363,837, filed on Jul. 18, 2016.

(51) Int. Cl. H04W 28/06; H04L 1/00

(52) U.S. Cl. CPC H04W 28/06; H04L 1/0004; H04L 1/0003; H04B 7/0413; H04L 1/0009; H04L 1/0019

(57) ABSTRACT

Certain aspects of the present disclosure provide methods and apparatus for efficiently signaling multiple modulation and coding schemes (MCSs) for different streams of multiple-input multiple-output (MIMO) transmission. Certain aspects provide an apparatus including a processing system configured to generate a frame with a payload and a header portion. The header portion may include a first set of bits indicating a plurality of MCSs and a second set of one or more bits indicating, for each portion of a plurality of portions of the payload, one of the plurality of MCSs used to encode the corresponding portion of the payload. In certain aspects, the apparatus also include an interface configured to output the frame for transmission.

### CLAIM OF PRIORITY UNDER 35 U.S.C. § 119

The present application claims the benefit of U.S. Provisional Patent Application Ser. No. 62/363,837, entitled “MULTIPLE MODULATION AND CODING SCHEME INDICATION SIGNALING” and filed Jul. 18, 2016, which is assigned to the assignee of the present application and hereby expressly incorporated by reference herein in its entirety.

### FIELD

Certain aspects of the present disclosure generally relate to wireless communications and, more particularly, to signaling modulation coding schemes.

### BACKGROUND

In order to address the issue of increasing bandwidth requirements demanded for wireless communications systems, different schemes are being developed to allow multiple user terminals to communicate with a single access point by sharing the channel resources while achieving high data throughputs. Multiple-input multiple-output (MIMO) technology represents one such approach that has recently emerged as a popular technique for next generation communication systems. MIMO technology has been adopted in several emerging wireless communications standards, such as the Institute of Electrical and Electronics Engineers (IEEE) 802.11 standard. The IEEE 802.11 standard denotes a set of Wireless Local Area Network (WLAN) air interface standards developed by the IEEE 802.11 committee for short-range communications (e.g., tens of meters to a few hundred meters).

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

In wireless networks with a single Access Point (AP) and multiple user stations (STAs), concurrent transmissions may occur on multiple channels toward different stations, both in the uplink and downlink direction. Many challenges are present in such systems.

### SUMMARY

Certain aspects of the present disclosure provide an apparatus for wireless communications. The apparatus generally includes a processing system configured to generate a frame with a payload and a header portion, wherein the header portion comprises a first set of bits indicating a plurality of modulation and coding schemes (MCSs) and a second set of bits indicating, for each portion of a plurality of portions of the payload, one of the plurality of MCS used to encode the corresponding portion of the payload and an interface configured to output the frame for transmission.

Certain aspects of the present disclosure provide an apparatus for wireless communications. The apparatus generally includes an interface configured to obtain a frame with a payload and a header portion, wherein the header portion comprises a first set of bits indicating a plurality of modulation and coding schemes (MCSs) and a second set of bits indicating, for each portion of a plurality of portions of the payload, one of the plurality of MCS used to encode a corresponding portion of the payload and a processing system configured to determine, based on the first set of bits and the second set of bits, which of the plurality of MCSs was used to encode portions of the payload and to process the frame based on the determination.

Certain aspects of the present disclosure provide a method for wireless communications by an apparatus. The method generally includes generating a frame with a payload and a header portion, where the header portion includes a first set of bits indicating a plurality of MCSs and a second set of one or more bits indicating, for each portion of a plurality of portions of the payload, one of the plurality of MCSs used to encode the corresponding portion of the payload, and outputting the frame for transmission.

Certain aspects of the present disclosure provide a method for wireless communications by an apparatus. The method generally includes obtaining a frame with a payload and a header portion, where the header portion includes a first set of bits indicating a plurality of MCSs and a second set of one or more bits indicating, for each portion of a plurality of portions of the payload, one of the plurality of MCSs used to encode the corresponding portion of the payload, determining, based on the first set of bits and the second set of bits, which of the plurality of MCSs was used to encode the corresponding portion of the payload. The method also includes processing the frame based on the determination.

Certain aspects of the present disclosure provide an apparatus for wireless communications. The apparatus generally includes means for generating a frame with a payload and a header portion, where the header portion includes a first set of bits indicating a plurality of MCSs and a second set of one or more bits indicating, for each portion of a plurality of portions of the payload, one of the plurality of MCSs used to encode the corresponding portion of the payload, and means for outputting the frame for transmission.

Certain aspects of the present disclosure provide an apparatus for wireless communications. The apparatus generally includes means for obtaining a frame with a payload and a header portion, where the header portion includes a first set of bits indicating a plurality of MCSs and a second set of one or more bits indicating, for each portion of a plurality of portions of the payload, one of the plurality of MCSs used to encode the corresponding portion of the payload; means for determining, based on the first set of bits and the second set of bits, which of the plurality of MCSs was used to encode the corresponding portion of the payload. The apparatus also includes means for processing the frame based on the determination.

Certain aspects of the present disclosure provide a wireless node. The wireless node generally includes a processing system configured to generate a frame with a payload and a header portion, where the header portion includes a first set of bits indicating a plurality of MCSs and a second set of one or more bits indicating, for each portion of a plurality of portions of a payload, one of the plurality of MCSs used to encode the corresponding portion of the payload, and a transmitter configured to transmit the frame.

Certain aspects of the present disclosure provide a wireless node. The wireless node generally includes a receiver configured to receive a frame with a payload and a header portion, where the header portion includes a first set of bits indicating a plurality of MCSs and a second set of one or more bits indicating, for each portion of a plurality of portions of the payload, one of the plurality of MCSs used to encode the corresponding portion of the payload, and a processing system configured to determine, based on the first set of bits and the second set of bits, which of the plurality of MCSs was used to encode the corresponding portion of the payload and to process the frame based on the determination.

Certain aspects of the present disclosure provide a computer readable medium having instructions stored thereon for generating a frame with a payload and a header portion, where the header portion includes a first set of bits indicating a plurality of MCSs and a second set of one or more bits indicating, for each portion of a plurality of portions of the payload, one of the plurality of MCSs used to encode the corresponding portion of the payload, and outputting the frame for transmission.

Certain aspects of the present disclosure provide a computer readable medium having instructions stored thereon for obtaining a frame with a payload and a header portion, where the header portion includes a first set of bits indicating a plurality of MCSs and a second set of one or more bits indicating, for each portion of a plurality of portions of the payload, one of the plurality of MCSs used to encode the corresponding portion of the payload, determining, based on the first set of bits and the second set of bits, which of the plurality of MCSs was used to encode the corresponding portion of the payload, and processing the frame based on the determination.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a diagram of an example wireless communications network, in accordance with certain aspects of the present disclosure.

FIG. 2 is a block diagram of an example access point and example user terminals, in accordance with certain aspects of the present disclosure.

FIG. 3 illustrates an example frame format that may include one or more fields for signaling modulation and coding scheme (MCS) for multiple spatial streams, in accordance with certain aspects of the present disclosure.

FIG. 4 illustrates example operations for generating a frame with signaling indicating MCS for multiple spatial streams, in accordance with certain aspects of the present disclosure.

FIG. 4A illustrates example components capable of performing the operations shown in FIG. 4.

FIG. 5 illustrates example operations for processing a frame with signaling indicating MCS for multiple spatial streams, in accordance with certain aspects of the present disclosure.

FIG. 5A illustrates example components capable of performing the operations shown in FIG. 5.

FIGS. 6A and 6B illustrate different combinations of channels and spatial streams for which MCS may be signaled, in accordance with certain aspects of the present disclosure.

FIG. 7 illustrates an example two-tiered communication protocol with three spatial streams, in accordance with certain aspects of the present disclosure.

FIG. 8 illustrates an example two-tiered communication protocol for eight spatial streams and a single (e.g., wideband bonded) channel, in accordance with certain aspects of the present disclosure.

FIG. 9 illustrates an example two-tiered communication protocol for four channel aggregation, each with two spatial streams, in accordance with certain aspects of the present disclosure.

FIG. 10 illustrates an example format of a field for signaling MCS for different spatial streams, in accordance with certain aspects of the present disclosure.

### DETAILED DESCRIPTION

Certain aspects of the present disclosure provide methods and apparatus for efficiently signaling multiple modulation and coding schemes (MCSs) for different streams of multiple-input multiple-output (MIMO) transmission.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### AN EXAMPLE WIRELESS COMMUNICATION SYSTEM

The techniques described herein may be used for various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to simultaneously transmit data belonging to multiple user terminals. A TDMA system may allow multiple user terminals to share the same frequency channel by dividing the transmission signal into different time slots, each time slot being assigned to different user terminal. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The teachings herein may be incorporated into (e.g., implemented within or performed by) a variety of wired or wireless apparatuses (e.g., nodes). In some aspects, a wireless node implemented in accordance with the teachings herein may comprise an access point or an access terminal.

An access point (“AP”) may comprise, be implemented as, or known as a Node B, a Radio Network Controller (“RNC”), an evolved Node B (eNB), a Base Station Controller (“BSC”), a Base Transceiver Station (“BTS”), a Base Station (“BS”), a Transceiver Function (“TF”), a Radio Router, a Radio Transceiver, a Basic Service Set (“BSS”), an Extended Service Set (“ESS”), a Radio Base Station (“RBS”), or some other terminology.

An access terminal (“AT”) may comprise, be implemented as, or known as a subscriber station, a subscriber unit, a mobile station, a remote station, a remote terminal, a user terminal, a user agent, a user device, user equipment, a user station, or some other terminology. In some implementations, an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, a Station (“STA”), or some other suitable processing device connected to a wireless modem. Accordingly, one or more aspects taught herein may be incorporated into a phone (e.g., a cellular phone or smart phone), a computer (e.g., a laptop), a portable communication device, a portable computing device (e.g., a personal data assistant), an entertainment device (e.g., a music or video device, or a satellite radio), a global positioning system device, or any other suitable device that is configured to communicate via a wireless or wired medium. In some aspects, the node is a wireless node. Such wireless node may provide, for example, connectivity for or to a network (e.g., a wide area network such as the Internet or a cellular network) via a wired or wireless communication link.

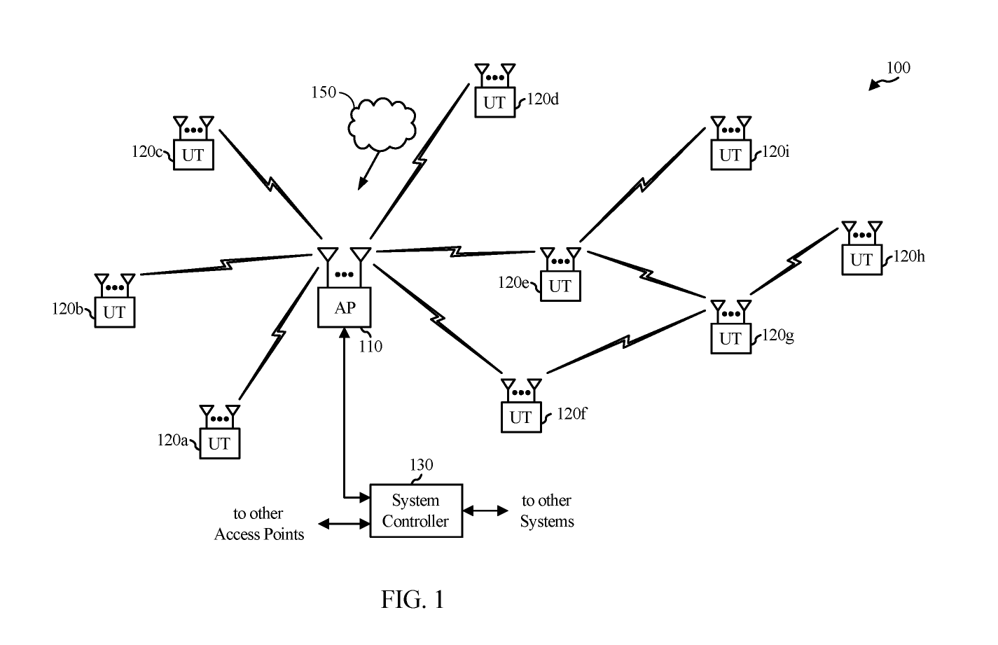

FIG. 1 illustrates a multiple-access multiple-input multiple-output (MIMO) system 100 with access points and user terminals. For simplicity, only one access point 110 is shown in FIG. 1. An access point is generally a fixed station that communicates with the user terminals and may also be referred to as a base station or some other terminology. A user terminal may be fixed or mobile and may also be referred to as a mobile station, a wireless device or some other terminology. Access point 110 may communicate with one or more user terminals 120 at any given moment on the downlink and uplink. The downlink (i.e., forward link) is the communication link from the access point to the user terminals, and the uplink (i.e., reverse link) is the communication link from the user terminals to the access point. A user terminal may also communicate peer-to-peer with another user terminal. A system controller 130 couples to and provides coordination and control for the access points.

While portions of the following disclosure will describe user terminals 120 capable of communicating via Spatial Division Multiple Access (SDMA), for certain aspects, the user terminals 120 may also include some user terminals that do not support SDMA. Thus, for such aspects, an access point (AP) 110 may be configured to communicate with both SDMA and non-SDMA user terminals. This approach may conveniently allow older versions of user terminals (“legacy” stations) to remain deployed in an enterprise, extending their useful lifetime, while allowing newer SDMA user terminals to be introduced as deemed appropriate.

The system 100 employs multiple transmit and multiple receive antennas for data transmission on the downlink and uplink. The access point 110 is equipped with Nₐₚ antennas and represents the multiple-input (MI) for downlink transmissions and the multiple-output (MO) for uplink transmissions. A set of K selected user terminals 120 collectively represents the multiple-output for downlink transmissions and the multiple-input for uplink transmissions. For pure SDMA, it is desired to have Nₐₚ≧K≧1 if the data symbol streams for the K user terminals are not multiplexed in code, frequency or time by some means. K may be greater than Nₐₚ if the data symbol streams can be multiplexed using TDMA technique, different code channels with code divisional multiple access (CDMA), disjoint sets of subbands with OFDM, and so on. Each selected user terminal transmits user-specific data to and/or receives user-specific data from the access point. In general, each selected user terminal may be equipped with one or multiple antennas (i.e., Nᵤₜ≧1). The K selected user terminals can have the same or different number of antennas.

The system 100 may be a time division duplex (TDD) system or a frequency division duplex (FDD) system. For a TDD system, the downlink and uplink share the same frequency band. For an FDD system, the downlink and uplink use different frequency bands. MIMO system 100 may also utilize a single carrier or multiple carriers for transmission. Each user terminal may be equipped with a single antenna (e.g., in order to keep costs down) or multiple antennas (e.g., where the additional cost can be supported). The system 100 may also be a TDMA system if the user terminals 120 share the same frequency channel by dividing transmission/reception into different time slots, each time slot being assigned to different user terminal 120.

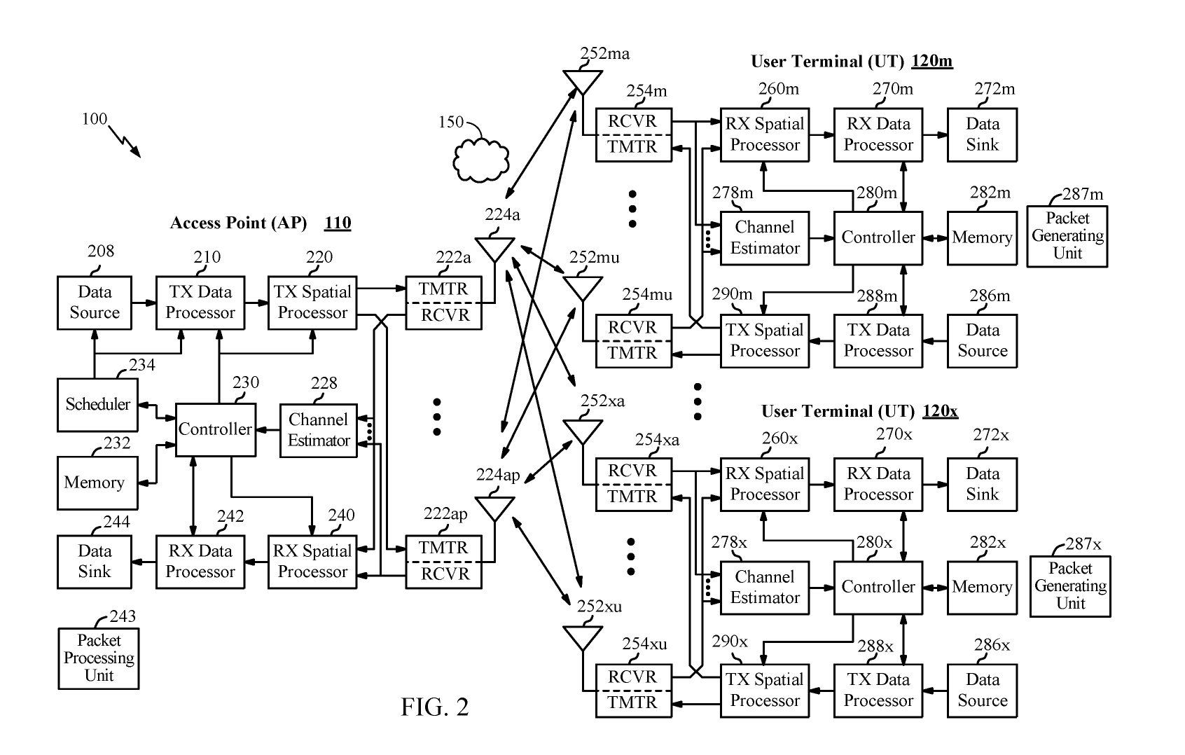

FIG. 2 illustrates a block diagram of access point 110 and two user terminals 120m and 120x in MIMO system 100. The access point 110 is equipped with Nₜ antennas 224a through 224t. User terminal 120m is equipped with N_{ut,m} antennas 252ma through 252mu, and user terminal 120x is equipped with N_{ut,x} antennas 252xa through 252xu. The access point 110 is a transmitting entity for the downlink and a receiving entity for the uplink. Each user terminal 120 is a transmitting entity for the uplink and a receiving entity for the downlink. As used herein, a “transmitting entity” is an independently operated apparatus or device capable of transmitting data via a wireless channel, and a “receiving entity” is an independently operated apparatus or device capable of receiving data via a wireless channel. In the following description, the subscript “dn” denotes the downlink, the subscript “up” denotes the uplink, Nup user terminals are selected for simultaneous transmission on the uplink, Ndn user terminals are selected for simultaneous transmission on the downlink, Nup may or may not be equal to Ndn, and Nup and Ndn may be static values or can change for each scheduling interval. The beam-steering or some other spatial processing technique may be used at the access point and user terminal.

On the uplink, at each user terminal 120 selected for uplink transmission, a TX data processor 288 receives traffic data from a data source 286 and control data from a controller 280. TX data processor 288 processes (e.g., encodes, interleaves, and modulates) the traffic data for the user terminal based on the coding and modulation schemes associated with the rate selected for the user terminal and provides a data symbol stream. A TX spatial processor 290 performs spatial processing on the data symbol stream and provides N_{ut,m} transmit symbol streams for the N_{ut,m} antennas. Each transmitter unit (TMTR) 254 receives and processes (e.g., converts to analog, amplifies, filters, and frequency upconverts) a respective transmit symbol stream to generate an uplink signal. N_{ut,m} transmitter units 254 provide N_{ut,m} uplink signals for transmission from N_{ut,m} antennas 252 to the access point.

Nup user terminals may be scheduled for simultaneous transmission on the uplink. Each of these user terminals performs spatial processing on its data symbol stream and transmits its set of transmit symbol streams on the uplink to the access point.

At access point 110, Nₐₚ antennas 224a through 224ap receive the uplink signals from all Nup user terminals transmitting on the uplink. Each antenna 224 provides a received signal to a respective receiver unit (RCVR) 222. Each receiver unit 222 performs processing complementary to that performed by transmitter unit 254 and provides a received symbol stream. An RX spatial processor 240 performs receiver spatial processing on the Nₐₚ received symbol streams from Nₐₚ receiver units 222 and provides Nup recovered uplink data symbol streams. The receiver spatial processing is performed in accordance with the channel correlation matrix inversion (CCMI), minimum mean square error (MMSE), soft interference cancellation (SIC), or some other technique. Each recovered uplink data symbol stream is an estimate of a data symbol stream transmitted by a respective user terminal. An RX data processor 242 processes (e.g., demodulates, deinterleaves, and decodes) each recovered uplink data symbol stream in accordance with the rate used for that stream to obtain decoded data. The decoded data for each user terminal may be provided to a data sink 244 for storage and/or a controller 230 for further processing.

On the downlink, at access point 110, a TX data processor 210 receives traffic data from a data source 208 for Ndn user terminals scheduled for downlink transmission, control data from a controller 230, and possibly other data from a scheduler 234. The various types of data may be sent on different transport channels. TX data processor 210 processes (e.g., encodes, interleaves, and modulates) the traffic data for each user terminal based on the rate selected for that user terminal. TX data processor 210 provides Ndn downlink data symbol streams for the Ndn user terminals. A TX spatial processor 220 performs spatial processing (such as a precoding or beamforming, as described in the present disclosure) on the Ndn downlink data symbol streams, and provides Nₐₚ transmit symbol streams for the Nₐₚ antennas. Each transmitter unit 222 receives and processes a respective transmit symbol stream to generate a downlink signal. Nₐₚ transmitter units 222 providing Nₐₚ downlink signals for transmission from Nₐₚ antennas 224 to the user terminals.

At each user terminal 120, N_{ut,m} antennas 252 receive the Nₐₚ downlink signals from access point 110. Each receiver unit 254 processes a received signal from an associated antenna 252 and provides a received symbol stream. An RX spatial processor 260 performs receiver spatial processing on N_{ut,m} received symbol streams from N_{ut,m} receiver units 254 and provides a recovered downlink data symbol stream for the user terminal. The receiver spatial processing is performed in accordance with the CCMI, MMSE or some other technique. An RX data processor 270 processes (e.g., demodulates, deinterleaves and decodes) the recovered downlink data symbol stream to obtain decoded data for the user terminal.

At each user terminal 120, a channel estimator 278 estimates the downlink channel response and provides downlink channel estimates, which may include channel gain estimates, signal to noise ratio (SNR) estimates, noise variance and so on. Similarly, a channel estimator 228 estimates the uplink channel response and provides uplink channel estimates. Controller 280 for each user terminal typically derives the spatial filter matrix for the user terminal based on the downlink channel response matrix H_{dn,m} for that user terminal. Controller 230 derives the spatial filter matrix for the access point based on the effective uplink channel response matrix H_{up,eff}. Controller 280 for each user terminal may send feedback information (e.g., the downlink and/or uplink eigenvectors, eigenvalues, SNR estimates, and so on) to the access point. Controllers 230 and 280 also control the operation of various processing units at access point 110 and user terminal 120, respectively.

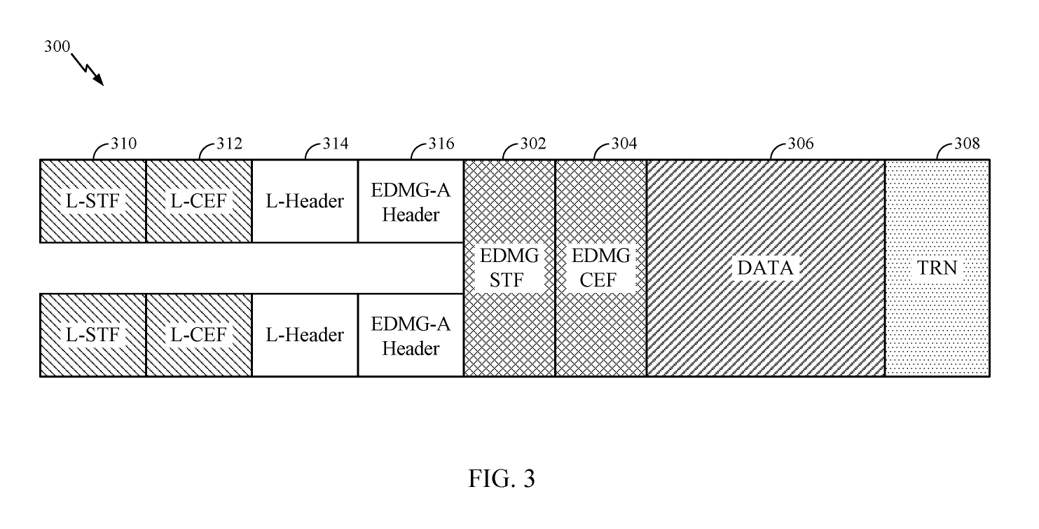

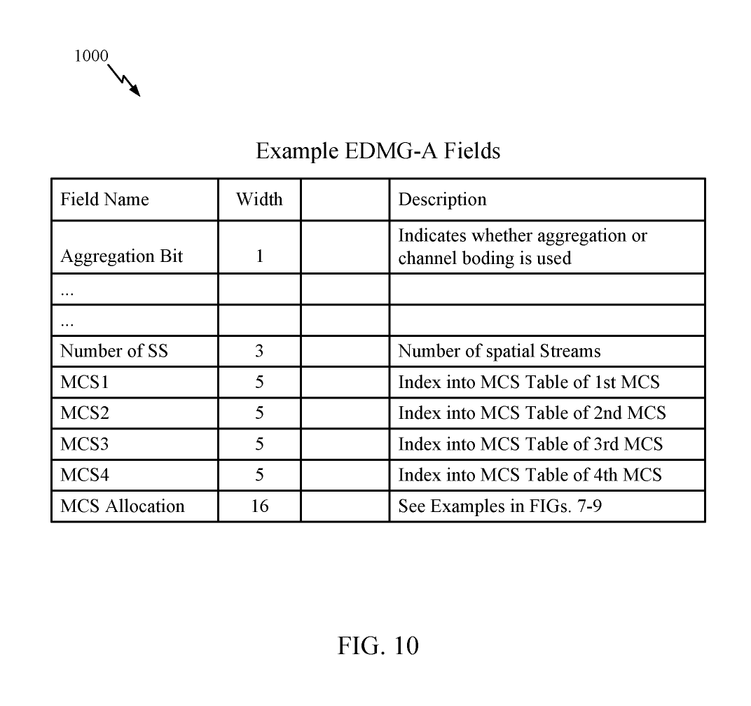

As illustrated, in FIGS. 1 and 2, one or more user terminals 120 may send one or more High Efficiency WLAN (HEW) packets 150, with a preamble format as described herein (e.g., in accordance with one of the example formats shown in FIGS. 3A-3B), to the access point 110 as part of a UL MU-MIMO transmission, for example. Each HEW packet 150 may be transmitted on a set of one or more spatial streams (e.g., up to 4). For certain aspects, the preamble portion of the HEW packet 150 may include tone-interleaved LTFs, subband-based LTFs, or hybrid LTFs (e.g., in accordance with one of the example implementations illustrated in FIGS. 10-13, 15, and 16).

The HEW packet 150 may be generated by a packet generating unit 287 at the user terminal 120. The packet generating unit 287 may be implemented in the processing system of the user terminal 120, such as in the TX data processor 288, the controller 280, and/or the data source 286.

After uplink (UL) transmission, the HEW packet 150 may be processed (e.g., decoded and interpreted) by a packet processing unit 243 at the access point 110. The packet processing unit 243 may be implemented in the process system of the access point 110, such as in the RX spatial processor 240, the RX data processor 242, or the controller 230. The packet processing unit 243 may process received packets differently, based on the packet type (e.g., with which amendment to the IEEE 802.11 standard the received packet complies). For example, the packet processing unit 243 may process a HEW packet 150 based on the IEEE 802.11 HEW standard, but may interpret a legacy packet (e.g., a packet complying with IEEE 802.11a/b/g) in a different manner, according to the standards amendment associated therewith.

Certain standards, such as the IEEE 802.11ay standard currently in the development phase, extend wireless communications according to existing standards (e.g., the 802.11ad standard) into the 60 GHz band. Example features to be included in such standards include channel aggregation and Channel-Bonding (CB). In general, channel aggregation utilizes multiple channels that are kept separate, while channel bonding treats the bandwidth of multiple channels as a single (wideband) channel.

FIG. 3 illustrates an example frame 300, in accordance with IEEE 802.11ay, that may be used to signal MCS for multiple data streams.

As illustrated, the frame 300 may have a preamble (header) structure for channel bonding (or aggregation) of at least two channels. The frame 300 may also have an enhanced directional multi gigabit (EDMG) short training field (STF) field 302 and EDMG channel estimation field (CEF) field 304, which may be constructed with Golay code sequences, a data payload 306 and training (TRN) field 308. The header may include fields transmitted on each bonded channel, such as an L-STF field 310, L-CEF field 312, L-Header field 314, and an EDMG-A header field 316. The “L” in labels L-STF, L-CEF, and L-Header indicate these fields may all be recognizable by “legacy” devices and, thus, promote interoperability. In certain aspects, the EDMG STF field 302 time domain processing may be different from that of the EDMG-A header field 316. For example, the EDMG STF field 302 and the EDMG-A header field 316 may be implemented with different block sizes and phase noise correction.

In some cases, a receiving device may need to know certain information at the beginning of the EDMG-STF field 302. For example, the receiver may need to know the whether single-carrier (SC) or OFDM modulation is used, the bandwidth that is used, whether channel aggregation is used, and whether single-input single-output (SISO) or MIMO is used for transmission of the frame 300.

In certain aspects of the present disclosure, certain indications may be assigned to the EDMG-A header field 316 as they may not be urgently needed in the L-header field 314 and may not be necessary for legacy devices. For example, four bits used to indicate the last received signal strength indicator (RSSI), one bit for packet type, one bit for aggregation indication, five bits of the TRN length, and the lower five bits of the length field, may be assigned to the EDMG-A header field 316. In certain aspects of the present disclosure, the L-header field 314 may include one bit to indicate whether SC or OFDM is used, eight bits to indicate bandwidth, one bit to indicate whether channel aggregation is used, and one bit to indicate whether SISO or MIMO is used. These fields may be signaled in portions of the L-header field 314 that were previously (e.g., in IEEE 802.11ad) used to indicate the last RSSI, the packet type, aggregation, and a portion of the length field. In certain aspects, an additional bit may be used to indicate whether single-user (SU) or multi-user (MU) format is used.

### EXAMPLE SIGNALING OF MULTIPLE MCS FOR MULTIPLE STREAMS

The 802.11ay standard for 60 GHz communication that is under development in the 802.11 working group under task group TGay may be considered an enhancement of the existing 802.11TGad (DMG-Directional Multi-Gigabit) standard. This standard may increase the physical layer (PHY) throughput in 60 GHz by using methods such as MIMO and channel bonding/channel aggregation.

In general, the difference between channel bonding and channel aggregation is that in channel bonding a wider channel is created while in channel aggregation multiple standard bandwidth channels are used together. The packet structure for SU MIMO typically includes a preamble (STF, CEF), a legacy header for compatibility, an EDMG-A header (Enhanced DMG) EDMG training fields (STF, CEF) and then EDMG (11ay modulation) data.

The standard may also support MIMO configurations, for example, of up to eight spatial streams and up to four channels in aggregation. In theory, each of these spatial streams may have a different modulation and coding scheme (MCS). In some cases, the EDMG-A header as illustrated in FIG. 3 may have 112 bits for indicating features, many of which may be needed for purposes other than signaling MCS for different spatial streams. A challenge is thus presented in how to indicate the MCS for the different MIMO streams and different channels in aggregation in an efficient manner.

Certain standards, such as the IEEE 802.11n standard, may not support channel aggregation. However, other standards such as the IEEE 802.11ay may support up to four spatial streams. Multiple MCSs may be indicated by indices in a table in which all valid MCS combinations for different numbers of streams are listed. On the other hand, the 802.11ac standard supports up to eight spatial streams and a form of channel aggregation, but it does not support different MCSs in either spatial streams or aggregation.

In a system that supports multiple spatial streams (e.g., up to eight possible spatial streams) and aggregation of multiple channels (e.g., up to four channels), the number of possible MCS combinations, if each of them gets a different MCS, is on the order of

$$\frac{{N}_{MCS}^{32}}{2} .$$

Therefore, 32·log₂(N_{MCS}) bits may be used for representation of the MCSs. Given that the currently supported number of MCSs (N_{MCS}) is 19 and is expected to grow, about 1024 bits may be used to represent MCSs.

Aspects of the present disclosure provide various mechanisms that provide an efficient manner for representing MCSs in the header. These mechanisms may include one or more of the following: limiting the total number of different MCSs used (e.g., to four MSCs), or limiting the number of spatial streams and channel aggregation combinations to eight. For example, two spatial streams may be used for each aggregated channel when there are four channels or four streams may be used for each aggregated channel when there are two aggregated channels. In some cases, the aggregated channels may be limited to using the same number of spatial streams.

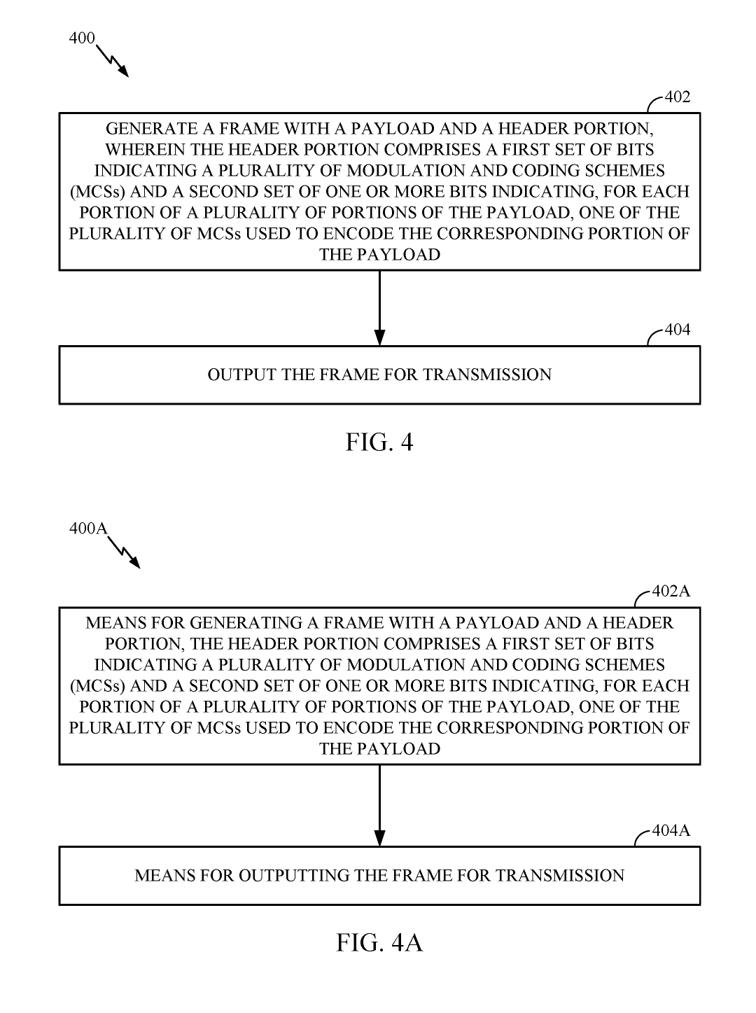

FIG. 4 illustrates example operations 400 for generating a frame including signaling to indicate MCS for multiple spatial streams, in accordance with certain aspects of the present disclosure. The operations 400 may be performed by a wireless node, such as the access point 110 or user terminal 120 of FIG. 2.

The operations 400 begin, at block 402, by generating a frame with a payload and a header portion, wherein the header portion includes a first set of bits indicating a plurality of MCSs and a second set of bits indicating, for each portion of a plurality of portions of the payload, one of the plurality of MCSs used to encode the corresponding portion of the payload. For example, each portion of the payload may be transmitted using a different spatial stream. At block 404, the frame is output for transmission.

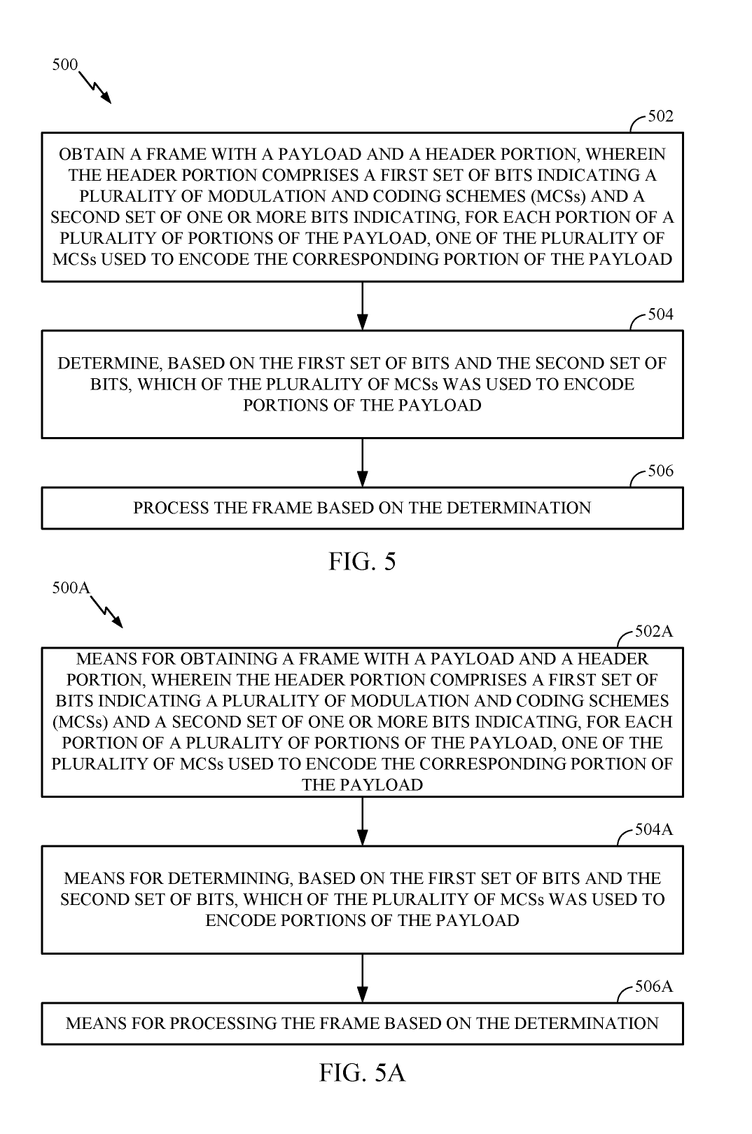

FIG. 5 illustrates example operations 500 for processing a frame including signaling to indicate MCS for multiple spatial streams, in accordance with certain aspects of the present disclosure. The operations 500 may be considered complementary to operations 400 and may be performed by a wireless node (e.g., access point 110 or user terminal 120) receiving a frame generated and outputted for transmission in accordance with operations 400.

Operations 500 begin, at 502, by obtaining a frame with a payload and a header portion, wherein the header portion comprises a first set of bits indicating a plurality of MCSs and a second set of bits indicating, for each portion of a plurality of portions of the payload, one of the plurality of MCSs used to encode the corresponding portion of the payload. At block 504, which of the plurality of MCSs was used to encode portions of the payload is determined, based on the first set of bits and the second sets of bit. At block 506, the frame is processed based on the determination.

As illustrated by the operations described above, a two tier signaling operation may be used to indicate the MCS for different combinations. For example, in the first tier, a first set of bits (e.g., in the EDMG-A header) may be used to indicate a limited subset of all possible MCSs that are used to encode data transmitted using the multiple spatial streams. This may be reasonable, as it is likely only a set of the possible MCSs are used in any given transmission. As an example, four different MCSs may be represented with five bits each. Thus, these bits may correspond to the first set of bits referenced above in FIGS. 4 and 5.

Continuing with the example above, two bits may be provided for each stream to select one of the limited subset of four different MCSs. In this case, to support up to eight spatial streams, a table or “bitmap” of eight two-bit indices may be used to indicate the MCS used in each particular stream. Thus, these bits may correspond to the second set of bits referenced above in FIGS. 4 and 5.

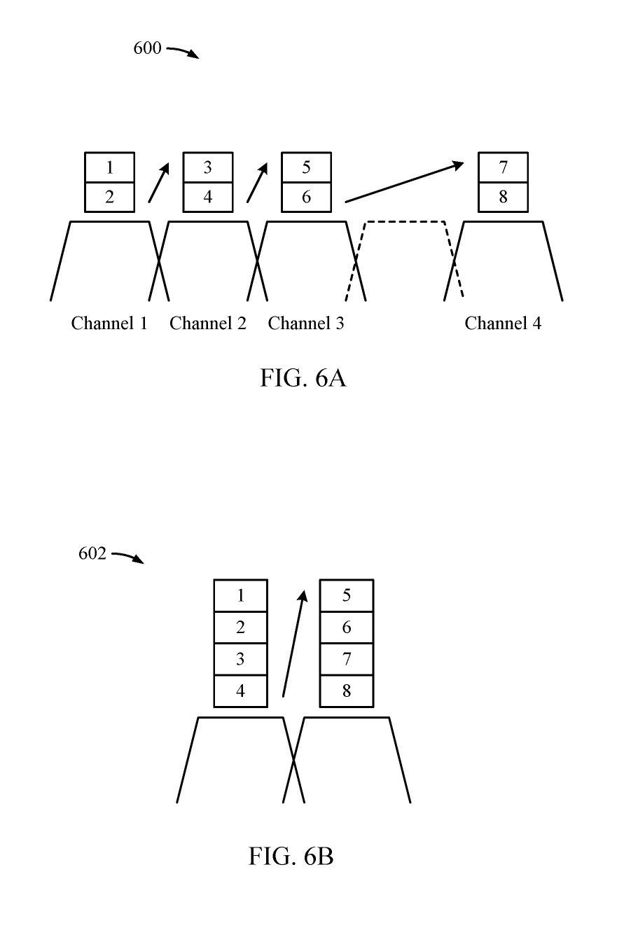

FIGS. 6A and 6B are diagrams 600 and 602 illustrating techniques for signaling different combinations of channels and spatial streams, in accordance with certain aspects of the present disclosure. For example, continuing with the example of eight total spatial streams, the diagram 600 illustrates four channels with two spatial streams each. In certain aspects, the channels may be discontinuous. The spatial streams may be indicated in the order of the channels. For example, the first two indices may correspond to the spatial streams of channel one, the second two indices may correspond to the spatial streams of channel two, and so on. As illustrated in diagram 602, eight spatial streams may also be configured as four streams for each of two different channels.

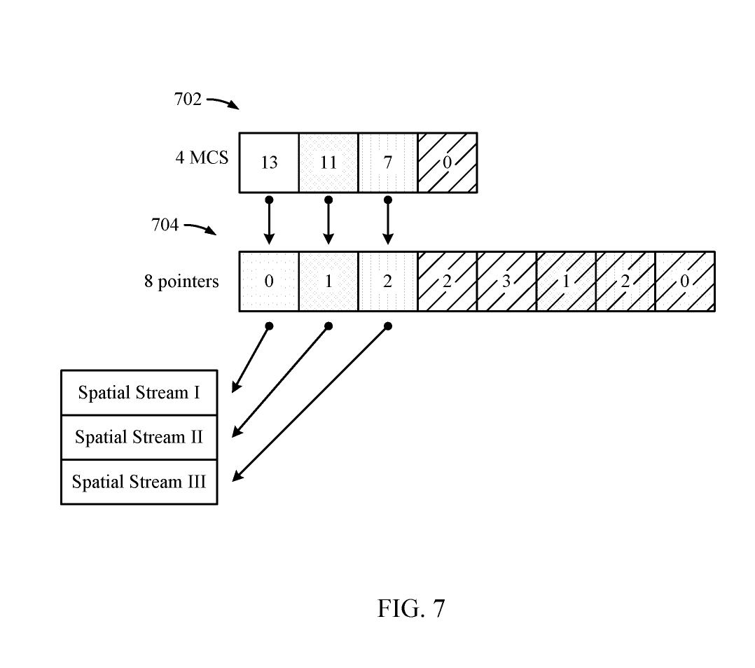

FIGS. 7-9 illustrate different configurations of multi-tiered signaling of MCSs for different spatial streams, in accordance with certain aspects of the present disclosure. In the following examples, a first set of bits 702, having four sets of five bits, serves as an MCS allocation table. Moreover, a second set of bits 704 may include sixteen bits which are grouped into eight two-bit MCS indices, each pointing to one of the five-bit MCS values in the MCS allocation table.

FIG. 7 shows an example two-tiered communication protocol with three spatial streams, in accordance with certain aspects of the present disclosure. In this example, each two-bit MCS index of the second set of bits 704 indicates one of the three MCSs, represented by the first set of bits 702, for one of the three spatial streams. As only three spatial streams are used, only three actual MCS values may be signaled and the other bits in the second set of bits (for streams 4-8) may be unused.

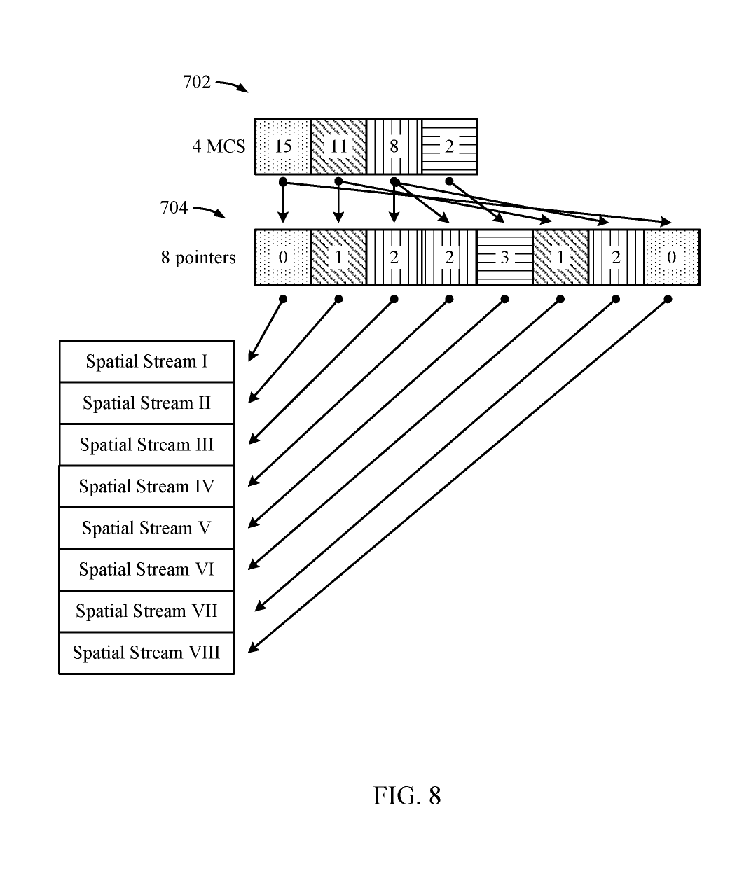

FIG. 8 shows an example two-tiered communication protocol for eight spatial streams and a single (e.g., wideband bonded) channel, in accordance with certain aspects of the present disclosure. In this case, each two-bit MCS index of the second set of bits 704 indicates one of the four MCSs, represented by the first set of bits 702, for one of the eight spatial streams.

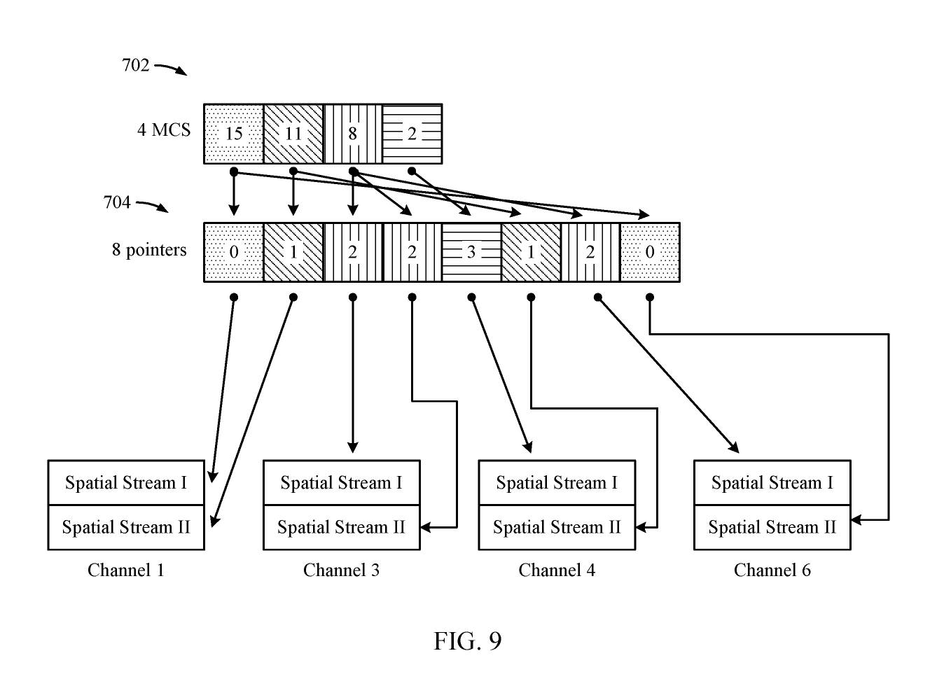

FIG. 9 illustrates an example two-tiered communication protocol for four channel aggregation, each with two spatial streams, in accordance with certain aspects of the present disclosure. As described with respect to FIGS. 6A and 6B, the spatial streams may be indicated in the order of the channels. For example, the first two-bit MCS index (e.g., pointer) of the second set of bits 704 may indicate the MCS for the first spatial stream of channel one, the second two-bit MCS index may indicate the MCS for the second spatial stream of channel two, and so on, as illustrated. In certain aspects, the number of spatial streams and aggregated channels may be indicated in other fields. The exact order of MCS index to spatial stream in the bitmap may depend on whether or not aggregation is used. In some cases, spatial streams may be allocated in the MCS allocation table from first to last. When channel aggregation is used, MCS may be allocated per each channel from the first stream to the last. In some cases an aggregation bit, indicating whether channel aggregation is used, may be provided in the same field (e.g., EDMG-A field) as the MCS table and index bits or the aggregation bit may be provided in an earlier field, allowing a receiving device to know how to interpret the MCS table and index bits that follow.

Of course, the number of bits in the MCS table and MCS index bitmap described herein are only exemplary and other values (number of MCSs indicated in the table) and, therefore, number of bits in each index may vary. For example, it is possible to reduce the MCS table to two MCSs. In this case, one bit indication may be used in the MCS allocation table. Further, it is possible to increase the MCS allocation table to nine entries, allowing three channel aggregation with three spatial streams.

FIG. 10 is a table 1000 illustrating an example format of a field for signaling MCS for different spatial streams, in accordance with certain aspects of the present disclosure. The field may, for example, be an EDMG-A field. As illustrated, in some cases, the field may include the aforementioned aggregation bit, an indication of the number of spatial streams, and bits for the MCS table. In this example, four five-bit fields allow signaling of four MCS values, labeled MCS1, MCS2, MCS3, and MCS4. An MCS allocation bitmap follows. In this example, sixteen bits allow for the allocation of eight spatial streams, each of one of the four MCS values.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering. For example, operations 400 illustrated in FIG. 4 correspond to means 400A illustrated in FIG. 4A while operations 500 illustrated in FIG. 5 correspond to means 500A illustrated in FIG. 5A.

For example, means for transmitting (or means for outputting for transmission) may comprise a transmitter (e.g., the transmitter unit 222) and/or an antenna(s) 224 of the access point 110 or the transmitter unit 254 and/or antenna(s) 252 of the user terminal 120 illustrated in FIG. 2. Means for receiving (or means for obtaining) may comprise a receiver (e.g., the receiver unit 222) and/or an antenna(s) 224 of the access point 110 or the receiver unit 254 and/or antenna(s) 252 of the user terminal 120 illustrated in FIG. 2. Means for processing, means for obtaining, means for generating, means for selecting, means for decoding, or means for determining, may comprise a processing system, which may include one or more processors, such as the RX data processor 242, the TX data processor 210, the TX spatial processor 220, and/or the controller 230 of the access point 110 or the RX data processor 270, the TX data processor 288, the TX spatial processor 290, and/or the controller 280 of the user terminal 120 illustrated in FIG. 2.

In some cases, rather than actually transmitting a frame a device may have an interface to output a frame for transmission (a means for outputting). For example, a processor may output a frame, via a bus interface, to a radio frequency (RF) front end for transmission. Similarly, rather than actually receiving a frame, a device may have an interface to obtain a frame received from another device (a means for obtaining). For example, a processor may obtain (or receive) a frame, via a bus interface, from an RF front end for reception.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to “at least one of” a list of items refers to any combination of those items, including single members. As an example, “at least one of: a, b, or c” is intended to cover a, b, c, a-b, a-c, b-c, and a-b-c, as well as combinations that include multiples of one or more members (aa, bb, and/or cc).

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PI-W layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the wireless node, all which may be accessed by the processor through the bus interface. Alternatively, or in addition, the machine-readable media, or any portion thereof, may be integrated into the processor, such as the case may be with cache and/or general register files.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may be implemented with an ASIC (Application Specific Integrated Circuit) with the processor, the bus interface, the user interface in the case of an access terminal), supporting circuitry, and at least a portion of the machine-readable media integrated into a single chip, or with one or more FPGAs (Field Programmable Gate Arrays), PLDs (Programmable Logic Devices), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. An apparatus for wireless communications, comprising:
a processing system configured to generate a frame with a payload and a header portion, wherein the header portion comprises a first set of bits indicating a plurality of modulation and coding schemes (MCSs) and a second set of one or more bits indicating, for each portion of a plurality of portions of the payload, one of the plurality of MCSs used to encode the corresponding portion of the payload; and
an interface configured to output the frame for transmission.

2. The apparatus of claim 1, wherein the header portion also has at least one bit indicating whether the frame is transmitted using channel bonding or channel aggregation.

3. The apparatus of claim 2, wherein the at least one bit is included in a first field occurring at a location earlier in the header portion than the first and second sets of bits.

4. The apparatus of claim 1, wherein the plurality of MCSs represents a subset of MCSs supported by the apparatus.

5. The apparatus of claim 1, wherein the first set of bits comprises:
different subsets of one or more bits, each subset indicating an MCS index corresponding to one of the plurality of MCSs.

6. The apparatus of claim 5, wherein:
each of the plurality of portions of the payload is outputted for transmission via a different spatial stream of a plurality of spatial streams; and
the second set of one or more bits indicates one of the MCS indices for each spatial stream of the plurality of spatial streams.

7. The apparatus of claim 6, wherein:
the plurality of MCSs comprises at least three MCSs; and
the second set of one or more bits comprises at least two bits indicating one of the at least three MCSs for each spatial stream of the plurality of spatial streams.

8. The apparatus of claim 6, wherein the interface is configured to output the frame for transmission:
using channel aggregation of at least a first channel and a second channel; and
using at least two of the plurality of spatial streams for the first channel and at least two of the plurality of spatial streams for the second channel.

9. The apparatus of claim 8, wherein the first and second channels are discontinuous.

10. An apparatus for wireless communications, comprising:
an interface configured to obtain a frame with a payload and a header portion, wherein the header portion comprises a first set of bits indicating a plurality of modulation and coding schemes (MCSs) and a second set of one or more bits indicating, for each portion of a plurality of portions of the payload, one of the plurality of MCSs used to encode the corresponding portion of the payload; and
a processing system configured to:
determine, based on the first set of bits and the second set of bits, which of the plurality of MCSs was used to encode the corresponding portion of the payload; and
process the frame based on the determination.

11. The apparatus of claim 10, wherein:
the header portion further comprises at least one bit indicating whether the frame was transmitted using channel bonding or channel aggregation; and
the determination is further based on the at least one bit.

12. The apparatus of claim 10, wherein:
the first set of bits comprises different subsets of one or more bits, each subset indicating an MCS index corresponding to one of the plurality of MCSs; and
the processing system is configured to determine each of the plurality of MCSs based on the MCS index indicated by each of the different subsets.

13. The apparatus of claim 12, wherein:
each of the plurality of portions of the payload is obtained via a different spatial stream of a plurality of spatial streams; and
the second set of one or more bits indicates one of the MCS indices for each spatial stream of the plurality of spatial streams.

14. The apparatus of claim 13, wherein:
the plurality of MCSs comprises at least three MCSs; and
the second set of one or more bits comprises at least two bits indicating one of the at least three MCSs for each spatial stream of the plurality of spatial streams.

15. The apparatus of claim 13, wherein the interface is configured to obtain the frame:
using channel aggregation of at least a first channel and a second channel; and
using at least two of the plurality of spatial streams for the first channel and at least two of the plurality of spatial streams for the second channel.

16. The apparatus of claim 15, wherein the first and second channels are discontinuous.

17-48. (canceled)

49. A wireless node, comprising:
a processing system configured to generate a frame with a payload and a header portion, wherein the header portion comprises a first set of bits indicating a plurality of modulation and coding schemes (MCSs) and a second set of one or more bits indicating, for each portion of a plurality of portions of the payload, one of the plurality of MCSs used to encode the corresponding portion of the payload; and
a transmitter configured to transmit the frame.

50-52. (canceled)

53. The apparatus of claim 10, wherein the interface comprises a receiver configured to receive the frame, and wherein the apparatus is configured as a wireless node.
